(19) United States
(12) Patent Application Publication
(10) Pub. No.: US 2025/0202002 A1
(43) Pub. Date: Jun. 19, 2025

(54) THERMALLY TRIGGERED PRIMER AND THERMOSETTING ADHESIVE MULTILAYER COMPOSITION FOR DETACHMENT OF EV BATTERY PACK

(71) Applicants: Dow Global Technologies LLC, Midland, MI (US); Dow Silicones Corporation, Midland, MI (US)

(72) Inventors: Yongchun Chen, Shanghai (CN); Qingwei Meng, Shanghai (CN); Yi Zhang, Shanghai (CN); Hongyu Chen, Shanghai (CN); Qi Gao, Shanghai (CN); Yanbin Fan, Shanghai (CN); Shouxue Guo, Shanghai (CN); Yongjin Guo, Shanghai (CN); Shaoguang Feng, Shanghai (CN)

(21) Appl. No.: 18/867,061

(22) PCT Filed: Jun. 30, 2022
(86) PCT No.: PCT/CN2022/102793

§ 371 Date: Nov. 19, 2024

(51) Int. Cl. H01M 50/233; H01M 50/218; H01M 50/249

(52) U.S. Cl. CPC H01M 50/233; H01M 50/218; H01M 50/249; H01M 2220/20

(57) ABSTRACT

Methods may include detaching a battery pack adhered to a substrate by a multilayer composition, including: heating the multilayer composition to a detachment temperature above 60° C. the multilayer composition comprising one or more thermoplastic primer layers having a transition temperature in the range of 60° C. to 120° C., and one or more thermoset adhesive layers; and separating one or more layers of the multilayer composition to detach the battery pack from the substrate, wherein the substrate has a surface energy of 35 dynes/cm or greater.

### FIELD

Embodiments relate to methods and systems including detachable battery assemblies produced with thermally detachable multilayer adhesive compositions.

### INTRODUCTION

Thermoplastic and thermoset adhesives are utilized in a number of industrial applications, including flexible packaging, and mounting electric vehicle (EV) batteries. For most applications, thermoset adhesives are selected on the basis of bonding strength, substrate compatibility, and long term durability under operating conditions. For a number of applications, however, adhered components must be separated for maintenance or replacement of parts. In order to detach an EV battery bonded to a thermoset adhesive layer, for example, physical removal methods are typically used, such as prying, cutting, or laser ablation. Other approaches involve the use of solvents or acids to remove the thermoset adhesive, which can generate chemical hazards and may provide limited penetration into an adhesive layer. Another concern with common detachment methods is the effectiveness in high surface area attachments, including those present in EV battery packs, which can lead to damage to adhered components.

### SUMMARY

Methods disclosed herein may include detaching a battery cell adhered to a substrate by a multilayer composition, including: heating the multilayer composition to a detachment temperature above 60° C., the multilayer composition comprising one or more thermoplastic primer layers having a transition temperature in the range of 60° C. to 120° C., and one or more thermoset adhesive layers; and separating one or more layers of the multilayer composition to detach the battery cell from the substrate, wherein the substrate has a surface energy of 35 dynes/cm or greater.

### DETAILED DESCRIPTION

Embodiments relate to methods and systems including detachable battery assemblies produced with thermally detachable multilayer adhesive compositions. Particularly, methods include detachment of one or more components of a battery assembly including a multilayer composition by directed heating from a heat source, such as a thermal management plate. In some cases, the thermal management plate (e.g., a water cooling plate for an EV battery) may be used to heat the multilayer compositions above the transition temperature of one or more thermoplastic layers (e.g., 50° C. to 130° C.), which enables the automatic or mechanically-assisted release of the thermoplastic primer layer from attached surfaces (e.g., high surface energy substrates, thermoset adhesive layer, etc.) with minimal deformation or damage.

Electric vehicle battery designs often include one or more battery packs containing a plurality of battery cells that are individually bonded to various types of substrates. EV batteries may also include a number of external features to protect battery packs and battery cell arrays, including a number of housings and substrates. With the large surface contact areas of battery components (e.g., around 0.5 m² for a pack block to 1.5 m² for a whole pack) and broad working temperature ranges (e.g., −20° C. to 60° C.), thermoset adhesives are often employed to provide bonding strength between the battery and underlying or above substrates and structures. The bonding strength of thermoset adhesives, however, makes it difficult to detach battery packs or pack substrates without damaging or deforming adhered components.

Methods and systems disclosed herein are directed to thermally detachable multilayer compositions for removably securing battery components (e.g., battery packs, battery cells) to various types of substrates. Multilayer compositions may include one or more thermoplastic primer layers and one or more thermoset adhesive layers interspersed between two substrates, such as one or more battery cells and pack substrates (e.g., battery pack cover, battery pack bottom, or thermal management plate). Thermoplastic primer layers disclosed herein may melt or soften at elevated temperature, which reduces the bonding strength of the adhesion of the multilayer composition and enables detachment of one or more of the constituent layers.

Thermoplastic primer resins disclosed herein may be detachably bonded to one or more of a thermoset adhesive layer, pack substrate, and/or thermal management plate. Thermoplastic primer layers may remain solid and maintain adhesive performance throughout operating temperatures for most applications (e.g., below or up to 50° C.), but soften and/or melt at temperatures above the glass transition temperature (T_{g}) or melt point temperature (Tₘ) of the thermoplastic adhesive. Thermoplastic primer layers disclosed herein may have glass transition temperatures (T_{g}) that range from 60° C. to 130° C., 60° C. to 120° C., 60° C. to 110° C., or 60° C. to 90° C.

Methods of detaching a battery pack adhered to a substrate by a multilayer composition may include heating the multilayer composition to a “detachment temperature” above 60° C. to induce softening or melting of the thermoplastic primer layers, followed by separating one or more layers of the multilayer composition to detach the battery pack from the substrate. Detachment methods may include mechanically separating the primer and/or adhesive layer from the substrate layer by a suitable technique such as prying, wedging, and/or impact. In some cases, gravity or other “passive” technique may be used to separate one or more layers of the multilayered composition.

Application of heat to a multilayer composition may include use of an external heat source such as an electric heating platform, electric heating pad, electric heating sheet, electric heating blanket, or the like, or an internal heat source such as the thermal management plate, thermal management pad, embedded heat elements, and the like. Thermal management plates are often used to maintain EV batteries within a steady temperature range (e.g., between −20° C. to 60° C.). During operation, the thermal management plate operates to dissipate or supply heat to the EV battery by passive (e.g., heat sink) or active (e.g., utilizing a flowing fluid or gas) heat transfer. Methods disclosed herein may utilize a thermal management plate or other method for direct heating of the primer and adhesive layers to a detachment temperature (i.e., above the transition temperature of the thermoplastic primer layer), while also minimizing the heat transfer from the heat source to the battery pack and subsequent battery damage.

During heating and detachment of the multilayer composition, methods and systems may utilize direct heating of the multilayer composition to minimize the measured temperature of the battery pack. If the battery cells are directly bonded with a substrate (e.g., a thermal management plate in EV battery pack), the substrate can function as an internal heat source. If the battery cells are directly bonded with pack substrate (e.g., bottom or cover in EV battery pack), the heat source may also be external, such as thermal management platform/pad/blanket contacting the multilayer composition. In either case, the use of an external or internal heat source produces an initial temperature increase at the contact site (e.g., the thermoplastic primer layer and/or thermoset adhesive layer), while the limitations of heat transfer result in delayed heating of distant components (e.g., a battery cell).

A series of finite element modeling experiments were conducted on a representative battery assembly containing a battery pack, multilayer composition, and an external thermal management plate. The experiments illustrated that heating by thermal management plate resulted in localized heating within the multilayer composition, while the adhered battery pack temperature was lower. Particularly, heating with a thermal management plate at a detachment temperature of 100° C. resulted in an increase in thermoplastic primer layer and thermoset adhesive layer temperature of up to 80° C. at 2 minutes, while the battery pack center reached 60° C. at 15 minutes and 80° C. at 30 minutes. The differential heat measurements between the battery pack battery cells and the multilayer composition indicate that a window exists where the battery pack may be detached from an underlying battery assembly component (e.g., substrates such as battery pack bottom, cover, etc.) during softening or melting of the thermoplastic primer layer and prior to exceeding the workable temperature bounds. For example, battery detachment may occur when the thermoplastic primer layer is at detachment temperature (e.g., 80° C. or more), while the EV battery remains within its upper workable temperature bounds, such as in a range of 60° C. to 80° C.

Methods disclosed herein may include detaching a battery pack when the measured battery pack temperature is at least 20° C., at least 10° C., or at least 5° C. below the detachment temperature. In some cases, methods of detaching a battery pack adhered to a substrate by a multilayer composition may include detaching the battery pack within 2 to 45 minutes, 2 to 30 minutes, or 2 to 20 minutes after heat is applied to the multilayer composition.

Multilayer compositions may include a high surface energy substrate onto which one or more thermoplastic primer layers and/or thermoset adhesive layers are formed, applied, or deposited. Examples of high surface energy substrates also include surfaces of battery components (e.g., battery pack or cell frame), substrate packs, thermal management plates, and other surfaces. Battery components disclosed herein may include EV battery packs and substrates, including prismatic or pouch cell-based batteries, cylindrical cell batteries, battery packs, and the like.

As used herein, “high surface energy substrate” refers to substrates having a surface energy of 35 dynes/cm or greater. High surface energy substrates disclosed herein include metals such as aluminum, steel or alloys, zinc, and the like, non-metals, including glass, polar polymers such as epoxy, polyurethane, or polyester, coated materials such as epoxy-coated aluminum, polyacrylate-coated aluminum, polyester liner-covered aluminum, and the like. Table 1 includes additional examples of suitable high energy substrates.

TABLE 1
Surface energy measurements for selected substrates

| | Surface Energy |
|---|---|
| Substrate | (dynes/cm) |
| Copper | 1103 |
| Aluminum | 840 |
| Zinc | 753 |
| Tin | 526 |
| Lead | 458 |
| Stainless Steel | 700-1100 |
| Glass | 250-500 |
| Polyimide | 50 |
| Epoxy | 43 |
| Phenolic | 47 |
| Nylon | 46 |
| ABS | 42 |
| Polyether sulfone | 46 |
| Styrene butadiene rubber | 48 |
| Polycarbonate | 46 |
| Polyethylene terephthalate | 43 |
| Polyurethane | 43 |

In some cases, high surface energy substrates may also be placed into contact with a multilayer composition containing one or more thermoplastic primer layers and/or thermoset adhesive layers that are assembled on a second substrate or surface. In some cases, multilayer composition may contain a thermoplastic primer layer contacting a high surface energy substrate, and a thermoset adhesive contacting the thermoplastic primer layer. The thermoset adhesive may also mediate adhesion to a second substrate, such as a thermal management plate.

In another example, a multilayer composition may contain a first thermoplastic primer layer contacting a high surface energy substrate, and a thermoset adhesive contacting the first thermoplastic primer layer. A second thermoplastic primer layer may be in contact the thermoset and mediating adhesion to a second substrate.

Multilayer compositions may include one or more thermoset adhesive layer, which can include one or more polyurethane, epoxy, polyacrylate, polyester, crosslinked derivatives thereof, and the like. Thermoset adhesives may include structural adhesives and/or thermal conductive adhesives having a thermal conductance of 0.2 W/mK or more, such as in a range of 0.2 W/mK to 3 W/mK. Thermoset adhesives disclosed herein may be water-borne, solvent-borne, or solventless.

Multilayer compositions disclosed herein may contain one or more thermoplastic primer layers including one or more thermoplastic polymers. Thermoplastic primer layers may include a maleic anhydride grafted chlorinated polyolefin (MAH-g-CPO) alone or in combination with one or more additional thermoplastic polymers. Maleic anhydride grafted chlorinated polyolefins disclosed herein may have a chlorination degree of 10% to 30%, and/or at least one maleic acid anhydride-modified polyolefin of 1% or more. Maleic anhydride grafted chlorinated polyolefins disclosed herein may have a weight average molecular weight of 50,000 Da or more, 60,000 Da or more, or 70,000 or more. Maleic anhydride grafted chlorinated polyolefins may have a weight average molecular weight of in a range of 40,000 Da to 100,000 Da, 50,000 Da to 90,000 Da, or 50,000 Da to 80,000 Da.

Thermoplastic primer layers may contain a MAH-g-CPO combined with one or more additional thermoplastic polymers, including polyurethane, polyesters, polyethers, polyacrylates, polycarbonates, maleic anhydride grafted polymers such as maleic anhydride grafted polyolefin (MAH-g-POE), maleic anhydride grafted ethylene-vinyl acetate (MAH-g-EVA), maleic anhydride grafted styrene-ethylene-butylene-styrene (MAH-g-SEBS), and the like. Thermoplastic primer layers may include one or more of polyolefin, ethyl vinyl acetate, acrylonitrile-butadiene rubber, butadiene styrene rubber; tackifier resins such as rosins, terpenes and modified terpenes, aliphatic, cycloaliphatic and aromatic resins (e.g., C5 aliphatic resins, C9 aromatic resins, and C5/C9 aliphatic/aromatic resins), hydrogenated hydrocarbon resins, terpene-phenol resins, novolacs, and the like; organic phase change materials (PCM) such as hydrocarbons, paraffins (e.g., CₙH₂ₙ₊₂) and lipids with 60° C. to 120° C. phase-changing temperatures; and liquid crystalline materials having phase change properties in a temperature range of 60° C. to 120° C.; and the like.

In some cases, the polarity of a thermoplastic primer layer containing MAH-g-CPO and one or more polar thermoplastic polymers may be tuned to minimize changes in lap shear strength and cross tensile strength resulting from incompatibility with the thermoset adhesive layer. For example, a thermoplastic primer compositions may be modified to include polar resins (e.g., at up to 45 wt %) to increase the adhesion to polar thermoset resins such as polyurethanes and epoxies.

Thermoplastic primer layers incorporating multiple polymers may include a MAH-g-CPO component at a percent by weight (wt %) of 55 wt % or more, 70 wt % or more, or 80 wt % or more. Thermoplastic primer layers may include MAH-g-CPO at a percent by weight (wt %) in a range of 55 wt % to 100 wt %, 60 wt % to 100 wt %, or 70 wt % to 100 wt %. Thermoplastic primer layers containing a mixture of resins may include MAH-g-CPO and one or more thermoplastic polymer components at a percent by weight (wt %) in a range of 0 wt % to 45 wt %. 0 wt % to 40 wt %, or 0 wt % to 30 wt %, with the balance as MAH-g-CPO and/or additives.

Thermoplastic primer layers may be applied to an adhesive layer and/or substrate layer as a solid, thin film, hot melt, or powder (e.g., 100 wt % solids). Thermoplastic primer layers may be generated by solvating a MAH-g-CPO resin, optionally with one or more additional thermoplastic polymers, in a suitable solvent, and depositing the resulting solvated resin composition on a substrate or surface. The solvent is then allowed to evaporate as the thermoplastic primer layer is formed. Suitable solvents may vary depending on the solubility of the selected primer resin or resin mixture, and may include aqueous or organic solvents. Mixtures of nonpolar and polar organic solvents may be used. Nonpolar solvents may include cycloalkyl or aromatic species such as methyl cyclohexane, toluene, and the like. Polar organic solvents may include methyl ethyl ketone, ethyl acetate, butyl acetate, and the like.

Organic solvated resin compositions may include one or more primer resins (e.g., solids) at a percent by weight (wt %) in a range of 1 wt % to 35 wt %, 1 wt % to 20 wt %, or 3 wt % to 20 wt %. Organic solvated resin compositions may include a nonpolar organic solvent at a percent by weight (wt %) in a range of 60 wt % to 99 wt %, 65 wt % to 99 wt %, or 70 wt % to 99 wt %. Organic solvated resin compositions may include a polar organic solvent at a percent by weight (wt %) in a range of 1 wt % to 40 wt %, 1 wt % to 45 wt %, or 1 wt % to 30 wt %.

Waterborne resin compositions may include one or more primer resins at a percent by weight (wt %) in a range of 15 wt % to 65 wt %, 20 wt % to 60 wt %, or 30 wt % to 55 wt %. Aqueous solvated resin compositions may include an aqueous fluid at a percent by weight (wt %) in a range of 35 wt % to 85 wt %, 40 wt % to 80 wt %, or 45 wt % to 70 wt %.

Thermoplastic primer layers disclosed herein may maintain good bonding strength relative to a bond between an adhesive layer and a substrate. Multilayer compositions disclosed herein may have a lap shear strength at room temperature that having less than a 30% decrease relative to a comparative multilayer composition without a thermoplastic primer layer. Multilayer compositions disclosed herein may have a cross tensile strength at room temperature that having less than a 30% decrease relative to a comparative multilayer composition without a thermoplastic primer layer.

Methods of preparing detachable multilayer compositions disclosed herein may include providing a substrate surface, one or more thermoplastic primer layers, and one or more thermoset adhesive layers. Thermoplastic primer layers and thermoset adhesive layers may be produced by solid deposition or by coating from solvent composition using known methods such as roller coating, flow coating, dip coating, spin coating, spray coating, knife coating, and die coating. Multilayer compositions disclosed herein may include a thermoplastic primer layer having a thickness in a range of 0.5 μm to 150 μm, 1 μm to 100 μm, or 5 μm to 90 μm.

Detachment of the substrate from the thermoplastic primer layers and/or the thermoset adhesive layers may include heating a multilayer composition to a temperature equal to or greater than 60° C.; and removing at least one of the layers of the multilayer composition. Methods of delivering the heat can include internal or external heating. Internal heating sources can include thermal management plate, resistive or inductive heating, or other contact-type heating element. External heating sources may include a heating platform, heating plate or table, heating blanket or sheet, heat gun, steam, and the like.

Detachment methods may include heating the multilayer composition to a temperature of 60° C. or more and mechanically separating the primer and/or adhesive layer from the substrate layer by a suitable technique such as prying, wedging, and/or impact.

Systems may include a detachable electric vehicle battery system, including an electrical vehicle battery; a multilayer composition adhering the battery to a pack substrate, the multilayer composition including one or more thermoplastic primer layers having a transition temperature in the range of 60° C. to 120° C., and one or more thermoset adhesive layers; a heat source in contact with the multilayer composition or functioning as a layer thereof (e.g., the thermoplastic primer layer or thermoset adhesive layer is bonded directly to a thermal management plate or other heat source); and wherein the pack substrate is one or more of a pack bottom, pack cover, or the heat source; wherein the heat source is configured to heat the multilayer composition to a detachment temperature in the range of 60° C. to 120° C. to enable detachment of the electric vehicle battery.

### EXAMPLES

The following examples are provided to illustrate the embodiments of the invention, but are not intended to limit the scope thereof. All parts and percentages are by weight unless otherwise indicated. The data and descriptive information provided herein are based on approximations. Table 2, lists the materials used in the following examples:

TABLE 2
Component chemicals used in the examples

| | | Melting | |
|---|---|---|---|
| Component | Description | point (° C.) | Supplier |
| Thermoset | Methylene diphenyl | — | Dow |
| PU | diisocyanate | | |
| | (MDI) based 2K | | |
| | polyurethane structural | | |
| | adhesive | | |
| MAH-g-CPO | Maleic anhydride-grafted | 70 | Toyobo |
| | chlorinated polyolefin | | |
| | (20 wt % Cl, 1.6 wt % | | |
| | MAH, Mw 75,000) | | |
| Hydrogenated | CAS number: 65997-06- | 72 | Fushan Baolin |
| rosin | 0; Acid number 160 mg | | Chemical |
| | KOH/g160; 10% | | Industry |
| | dehydroabietic acid; | | |

### Example 1: Detachment Methods Using Thermal Management Plate

In this example, a battery assembly was constructed using sample multilayer compositions to mediate adhesion between a commercial battery and a thermal management plate. Detachment properties of bonded battery assemblies were then tested using methods disclosed herein in which a thermal management plate was used to heat the multilayer composition to soften or melt the adhesive and/or primer layers to facilitate detachment.

Multilayer compositions contained the following layers described in Table 3, where the structural elements are as follows: “battery cell” included a commercial LiFePO₄ EV battery pack (size: Length/width/high=172 mm/166 mm/52.1 mm) with epoxy coated Type-3 Al surface; “primer layers” included MAH-g-CPO based primer with around 13 μm thickness; “adhesive layer” included a thermoset polyurethane adhesive (thermal conductivity 0.3 w/mK) and around 1 mm thickness; “pack substrate” included an epoxy coated Type-5 Al (5754) with 2 mm thickness; “thermal management plate” included a forced-circulation thermal management plate capable of heating up to 100° C.

Comparative (CE) and inventive examples (IE) were bonded by a polyurethane thermoset adhesives between the battery pack and the pack substrate. Thermoplastic primer layers used in the examples were generated by solubilizing primer resin particles of 7 parts MAH-g-CPO and 3 parts hydrogenated rosin in a 85:5 mixture of methyl cyclohexane and methyl ethyl ketone. Resin particles were added into the flask with 10 wt % solid contents and heated to 80° C. under stirring until dissolved. The primer resin mixture was then applied to the battery pack or pack substrate prior to application of the thermoset adhesive.

The detachability tests were conducted as follows. Step 1: samples were prepared according to Table 3 and aged for 1 week. Step 2: CE1 was placed in a 80° C. heated oven for 30 minutes. The remaining samples were placed on a preheated thermal management plate at 100° C. for 5 minutes, which can guarantee the temperature of primer layer and adhesive layer is over 80° C. after 5 minutes of heat transition. Step 3: Detaching test is manually carried out between high temperature battery cell and battery substrate in the help of a 21 cm length of a screwdriver. The tip of the screwdriver was placed between battery pack and pack substrate to pry the layers apart. If the sample could be manually detached in 5 minutes, it is defined as “Detachable”. If the sample could not be manually detached in 5 minutes, it is defined as “Not Detachable.” Similar tests could also be carried out in above samples at room temperature, to check the performance at room temperature.

TABLE 3
Sample design and detachment testing results for Example 1

| Examples | | CE1 | CE2 | IE1 | IE2 | IE3 |
|---|---|---|---|---|---|---|
| Structure | Battery cell | yes | yes | yes | yes | yes |
| (from | First primer | no | no | yes | no | yes |
| above to | layer | | | | | |
| bottom) | Thermoset | yes | yes | yes | yes | yes |
| | adhesive | | | | | |
| | layer | | | | | |
| | Second | no | no | no | yes | yes |
| | primer layer | | | | | |
| | Pack | yes | yes | yes | yes | yes |
| | substrate | | | | | |
| | Thermal | no | yes | yes | yes | yes |
| | management | | | | | |
| | plate | | | | | |

| | | | | | |
|---|---|---|---|---|---|
| Detachability at room | Not | Not | Not | Not | Not |
| temperature | detachable | detachable | detachable | detachable | detachable |
| Detachability at 100° C. | Not | Not | Detachable - | Detachable - | Detachable - |
| after 5 min | detachable | detachable | failure at | failure at | failure at |

| | | |
|---|---|---|
| first primer | second | either |
| layer | primer layer | primer layer |

Sample CE 1 is a multilayer composition with thermoset 2K PU adhesive without primer, in which the battery cell and the multilayer composition were heated under same conditions in an oven at a detachment temperature of 80° C. for 30 minutes. Subsequent attempts to detach the battery cell from the pack substrate failed, indicating that the thermoset 2 k PU adhesive had good bonding with battery cell and pack substrate even under high temperature (80° C.). CE2 is similar to CE1 but it was heated using a thermal management plate, however, the bonding strength of the thermoset adhesive with battery cell and pack substrate remained strong after heating and attempts at detachment failed. For IE1 to IE3 examples with thermoplastic primer layers, detachment was facilitated by softening or melting of the thermoplastic primer layer(s) heated to 80° C. (above the glass transition temperature of 70° C.), permitting detachment by manually prying.

While the foregoing is directed to exemplary embodiments, other and further embodiments may be devised without departing from the basic scope thereof, and the scope thereof is determined by the claims that follow.

1. A method of detaching a battery cell adhered to a substrate by a multilayer composition, comprising:
heating the multilayer composition to a detachment temperature above 60° C., the multilayer composition comprising one or more thermoplastic primer layers having a transition temperature in the range of 60° C. to 120° C., and one or more thermoset adhesive layers; and
separating one or more layers of the multilayer composition to detach the battery cell from the substrate,
wherein the substrate has a surface energy of 35 dynes/cm or greater.

2. The method of claim 1, wherein heating comprises heating the multilayer composition using a thermal management plate, pad, or blanket.

3. The method of claim 1, wherein heating comprises heating the multilayer composition using an internal thermal management system such as water cooling plate.

4. The method of claim 1, wherein the one or more thermoplastic primer layers comprise 55 wt % to 100 wt % of a maleic anhydride grafted chlorinated polyolefin.

5. The method of claim 1, wherein detaching comprises prying the multilayer composition.

6. The method of claim 1, wherein the multilayer composition comprises a thermoplastic primer layer in contact with the substrate.

7. The method of claim 1, wherein the multilayer composition comprises a thermoplastic primer layer in contact with the battery cell.

8. The method of claim 1, wherein the battery cell temperature is at least 5° C. below the detachment temperature of the multilayer composition.

9. A detachable electric vehicle battery system, comprising:
an electrical vehicle battery;
a multilayer composition adhering the battery to a pack substrate, the multilayer composition comprising one or more thermoplastic primer layers having a transition temperature in the range of 60° C. to 120° C., and one or more thermoset adhesive layers;
a heat source in contact with, or a layer of, the multilayer composition; and
wherein the pack substrate is one or more of a pack bottom, pack cover, or the heat source;
wherein the heat source is configured to heat the multilayer composition to a detachment temperature in the range of 60° C. to 120° C. to enable detachment of the electric vehicle battery.

10. The system of claim 8, wherein the one or more thermoplastic primer layers comprise 55 wt % to 100 wt % of a maleic anhydride grafted chlorinated polyolefin

11. The system of claim 8, wherein the heat source is a thermal management plate.
